(19) United States
(12) Patent Application Publication
(10) Pub. No.: US 2016/0020039 A1
(43) Pub. Date: Jan. 21, 2016

(54) MULTI-LAYER MESOPOROUS COATINGS FOR CONDUCTIVE SURFACES, AND METHODS OF PREPARING THEREOF

(71) Applicant: OneSun, LLC, Sausalito, CA (US)

(72) Inventors: Adam J. BURKETT, San Rafael, CA (US); Mats I. LARSSON, Sunnyvale, CA (US); Eitan C. ZEIRA, Hollis, NH (US)

(21) Appl. No.: 14/304,707

(22) Filed: Jun. 13, 2014

Related U.S. Application Data
(60) Provisional application No. 61/835,354, filed on Jun. 14, 2013.

(51) Int. Cl. H01G 9/20

(52) U.S. Cl. CPC H01G 9/2031

(57) ABSTRACT

Provided herein is a method of coating a conductive surface with a multi-layer mesoporous structure, by coating a conductive surface with a first photocatalytic dispersion to form a first layer over the conductive surface, curing or partially curing the first layer at temperatures of less than 400° C. to form a porous structure, and coating the porous first layer with the one or more additional photocatalytic dispersions to form one or more additional layers that can penetrate or partially penetrate the pores of the structure in the first layer. The first photocatalytic dispersion includes photocatalytic particles, polymeric binder and a dispersion medium. The one or more additional photocatalytic dispersions include photocatalytic particles and a dispersion medium.

### CROSS-REFERENCE TO RELATED APPLICATION

This application claims the benefit of U.S. Provisional Patent Application No. 61/835,354, filed on Jun. 14, 2013, the disclosure of which is hereby incorporated by reference in its entirety.

### FIELD

The present disclosure relates generally to photovoltaic devices, and more specifically to a two-layer mesoporous structure, and methods of preparing such structures, that can be used in photovoltaic cells and modules.

### BACKGROUND

Thin film photovoltaic (PV) cells made up of percolating networks of liquid electrolyte and dye-coated sintered titanium dioxide were developed by Dr. Michael Grätzel and coworkers at the Swiss Federal Institute of Technology, in the early eighties. See Int. J. Electrochem. Sci., Vol. 7, 2012. These PV devices fall within a general class of cells referred to as dye-sensitized solar cells (DSSCs). Conventionally, fabrication of DSSCs requires a high temperature sintering process, typically greater than about 400° C., to achieve sufficient interconnectivity and enhanced adhesion between the nanoparticles and a transparent substrate. Although Grätzel cells are fabricated from relatively inexpensive raw materials, the high temperature sintering technique used to make these cells limits the substrate choices to rigid transparent materials, such as glass, and consequently limits the manufacturing to high cost batch processes that compete with Silicon based solar cells. Furthermore, the high temperature sintering process increases the cost of manufacturing a photovoltaic cell due to the high energy requirement. In addition, DSSC cells may experience short operational lifetime as a result of the dye disrobing from the nanotitania particles. See J. Mater. Chem., 2003, 13, 877-882.

Thus, what is needed in the art is a commercially viable alternative method of preparing PV cells that have the mechanical robustness and efficient charge transport afforded by the high temperature sintering processes currently known and used in the art.

### BRIEF SUMMARY

Provided herein are methods to prepare a photocatalytic surface that can be coated at lower temperatures than what is currently used in the art, for example, involving the use of high temperature sintering processes. The methods described herein produce a multi-layer (e.g., a two-layer) surface that has both mechanical robustness and efficient charge transport suitable for use in a PV cell.

In one aspect, provided are methods for coating a conductive surface with a multi-layer porous (e.g., mesoporous) structure. In some embodiments, the method includes: (i) combining a plurality of first photocatalytic particles, binder (e.g., polymeric binder) and a first dispersion medium to form a first photocatalytic dispersion; (ii) coating a conductive surface with the first photocatalytic dispersion to form a first layer over the conductive surface; (iii) curing or partially curing the first layer at a temperature of less than 200° C. to form a porous first layer; (iv) combining a plurality of second photocatalytic particles and a second dispersion medium to form a second photocatalytic dispersion; and (v) coating the porous first layer with the second photocatalytic dispersion to form a second layer over the porous first layer. The formation of second layer over the porous first layer produces a conductive surface coated with a multi-layer porous (e.g., mesoporous) structure.

In other embodiments, the method includes: (i) combining a plurality of first N-type semiconductive particles, binder (e.g., polymeric binder), and a first dispersion medium to form a first semiconductive dispersion; (ii) coating a conductive surface with the first semiconductive dispersion to form a first layer over the conductive surface; (iii) curing or partially curing the first layer at a temperature of less than 200° C. to form a porous first layer; (iv) combining a plurality of second N-type semiconductive particles and a second dispersion medium to form a second semiconductive dispersion; and (v) coating the porous first layer with the second semiconductive dispersion to form a second layer over the porous first layer. The formation of second layer over the porous first layer produces a conductive surface coated with a multi-layer semiconductive structure.

Provided is also a multi-layer porous (e.g., mesoporous) structure coated onto a conductive surface according to any of the methods described above.

In other aspects, provided is a method of coating a porous oxide nano-layer with nano-sized pores of titanium dioxide (TiO₂). In some embodiments, the method includes: forming a first layer that includes nanotitania particles dispersed in a solution or emulsion of binder (e.g., polymeric binder) and solvent; and forming a second layer of a nanotitania dispersion of particles without a binder. In one variation, the second layer is formed on top of and/or within the first layer, and subsequent to the first layer. In another variation, the first layer is coated and allowed to cure prior to coating the second layer atop the first layer. In yet another variation, the second layer penetrates the first layer, such that the second layer is completely absorbed in the first layer. In yet another variation, multi layers of successive smaller particle size distribution layers creates a dense film filled with nanoparticles of different sizes.

In other embodiments, the method includes: forming a first layer made up of nanotitania particles dispersed in a solution or emulsion of binder (e.g., polymeric binder) and solvent; and forming several successive layers of a nanotitania dispersion of particles without a binder. The successive layers are coated on top of and subsequent to the first coating. In one variation, multi layers of successive smaller particle size distribution dispersions may be used to fully fill the first layer, creating a dense coating where a subsequent P-type material does not penetrate the porous titanium oxide layers. This variation of the method creates a bilayer P-N heterojunction.

In yet other embodiments, the method includes: forming a first layer made up of nanotitania particles dispersed in a solution or emulsion of binder (e.g., polymeric binder) and solvent; and forming a second coating of a nanotitania dispersion of particles without a binder. In one variation, the second layer is coated on top of and subsequent to the first coating. The second layer is used to partly fill the first layer where the P-type material partially penetrates the porous titanium dioxide layers. This variation of the method creates a P-N bulk heterojunction. In another variation, the second layer is coated on top of and subsequent to the first coating. The second layer is used to fully fill the first layer, creating a dense coating where a subsequent P-type material does not penetrate the porous titanium oxide layers. This variation of the method creates a Mayer P-N heterojunction.

Provided herein is also a porous oxide nano-layer coated with nano-sized pores of titanium dioxide (Ti according to any of the methods described above.

### DESCRIPTION OF THE FIGURES

The present disclosure can be best understood by reference to the following description taken in conjunction with the accompanying figures, in which like parts may be referred to by like numerals.

FIG. 1 depicts an SEM cross-section of a two-layer mesoporous structure layer prepared according to the procedure in Example 1. The porous nanostructured morphology is readily visible in middle layer of the figure. As observed in this Figure, the second layer does not fully penetrate the first layer.

FIG. 2 is a graph depicting a typical dark IV curve of a cell prepared according to the procedure in Example 3.

FIG. 3 is a graph depicting typical dark IV curve after light soaking of a cell prepared according to the procedure in Example 3.

FIG. 4A-4E are graphs that depict the cell performance of a lead sulfide (PbS) absorber coated on a two-layer mesoporous structure prepared according to the procedure in Example 3. FIG. 4A is graph depicting open circuit voltage under 1 sun illumination over time. FIG. 4B is graph depicting short circuit current under 1 sun illumination over time. FIG. 4C is graph depicting efficiency under 1 sun illumination over time. FIG. 4D is graph depicting IV curves at the beginning and end of the illumination test period. FIG. 4E is graph depicting power curves at the beginning and end of the illumination test period.

FIGS. 5A-5C are exemplary scanning electron microscope (SEM) images that each depict a cross-section of a two-layer mesoporous structure coated with a lead sulfide (PbS) layer. FIG. 5A depicts a two-layer mesoporous structure where the second layer is fully absorbed into the first layer. FIG. 5B depicts a two-layer mesoporous structure where the second layer is partially absorbed into the first layer. FIG. 5C depicts a two-layer mesoporous structure where the second layer remains on top of the first layer.

FIG. 6 is an SEM image depicting the cross-section of a two-layer mesoporous structure, using FTO-coated PET as the substrate, with perovskite deposited in the mesoporous structure, coated with a layer of 2,2′,7,7′-tetrakis[N,N-di(4-methoxyphenyl)amino]-9,9′-spirobifluorene (spiro-OMeTAD, also abbreviated as “Spiro” in the figure).

FIGS. 7A-7E are graphs that depict the cell performance of a perovskite absorber coated on a two-layer mesoporous structure. FIG. 7A is graph depicting open circuit voltage under 1 sun illumination over time. FIG. 7B is graph depicting short circuit current under 1 sun illumination over time. FIG. 7C is graph depicting efficiency under 1 sun illumination over time. FIG. 7D is graph depicting IV curves at the beginning and end of the illumination test period. FIG. 7E is graph depicting power curves at the beginning and end of the illumination test period.

### DETAILED DESCRIPTION

The following description sets forth numerous specific methods, configurations, parameters, and the like. It should be recognized, however, that such description is not intended as a limitation on the scope of the present invention, but is instead provided as a description of exemplary embodiments.

In one aspect, provided herein are methods of coating a conductive surface, such as the surface of indium tin oxide (ITO) or a halogenated tin oxide (e.g., fluorinated tin oxide (FTO)), with a multi-layer porous (e.g., mesoporous) structure. Such coating methods can be performed at temperatures lower than what are currently used in the art, e.g., for high temperature sintering.

In some embodiments, the method involves coating the conductive surface with photocatalytic particles dispersed in binder (e.g., polymeric binder) and a dispersion medium to form a first layer on the conductive surface. The first layer may be cured or partially cured at temperatures less than 400° C., including for example temperatures between 80° C. and 200° C. or between 100° C. and 150° C. Once cured, a porous first layer is formed. A second photocatalytic dispersion, which may contain the same or different type of photocatalytic particles as in the first layer, is coated over the first layer. The photocatalytic particles of the second dispersion can penetrate or partially penetrate the porous structure of the first layer. This penetration or partial penetration can create interconnected channels of interconnected particles or nanoparticles. The resulting structure formed over the conductive surface is a multi-layered porous structure that exhibits both mechanical robustness and efficient charge transport for use in PV cells.

Various P-type absorbers can then be incorporated into the resulting multi-layered structure. For example, P-type absorbers, or precursors thereof, may be incorporated into the multi-layer mesoporous structure produced according to the methods described herein. When P-type absorber precursors are used, such precursors may react in situ, .e.g., within the pores of the porous structure, to disperse the P-type absorbers within the pores of the porous structure.

The materials and conditions used in the methods, and the resulting porous (e.g., mesoporous) structures, are described in further detail below.

### Conductive Surface

The conductive material coated according to the methods described herein may be any material suitable for use in PV cells, LCD screens, touch screens and window heaters. In some embodiments, the conductive material may be any material that imparts conductivity and transparency; for example, conductivity being in the range of 5 to 200 ohm per square and transparency from 70-95% transmission in the range of 300-1000 nm wavelength. For example, the conductive material may be a conducting oxide. In certain embodiments, the conductive material is indium tin oxide (ITO). In other embodiments, the conductive material is a halogenated tin oxide, such as fluorinated tin oxide (FTO).

### First Layer

As described in the methods herein, a first layer is formed over the surface of the conductive material by: (i) forming a photocatalytic dispersion made up of photocatalytic particles, binder (e.g., polymeric binder) and a dispersion medium; (ii) coating the photocatalytic dispersion onto the conductive surface; and (iii) removing at least a portion of the dispersion medium from the coated layer to form a porous first layer.

The photocatalytic dispersion may be formed by applying the photocatalytic particles, binder (e.g., polymeric binder) and dispersion medium to a media mill such as ball mill, or any other appropriate stirring or dispersing device to disperse the photocatalytic particles in the medium used.

The photocatalytic dispersion can be coated over the conductive surface using any techniques known in the art. It should be understood that the coating method can depend on various factors, including the type of particles used, the type of binders used, the type of dispersion medium used (including, for example, the viscosity of the medium). For example, when a thermoplastic resin is used as the binder, flexographic or gravure coating methods may be used. One of skill in the art would recognize that thermoset resins, for example, typically-require a two feed and inline mixing system more conducive to slot die coating. Additionally, one of skill in the art would recognize that a viscosity of several cP (centipoise) typically requires the use of slot die or spray, while viscosities of several hundred cP typically require the use of gravure and Flexo.

Once the photocatalytic dispersion is coated onto the conductive surface, the dispersion medium is removed to create a porous structure. In some embodiments, the first layer is cured or partially cured at a temperature of less than 400° C., less than 350° C., less than 300° C., less than 250° C., less than 200° C., less than 175° C., less than 150° C., or less than 100° C.; or between 80° C. and 350° C., between 80° C. and 300° C., between 80° C. and 200° C., between 80° C. and 150° C., between 80° C. and 140° C., between 80° C. and 130° C., between 100° C. and 300° C., between 100° C. and 200° C., between 100° C. and 150° C., or between 100° C. and 130° C.; or about 100° C., 120° C., 125° C., 130° C., 135° C., 140° C., 145° C., 150° C. or 175° C. In some embodiments, the first layer is cured or partially cured at a temperature below the melting point of the conductive surface.

The curing or partial curing of the first layer may cause a cross-linking reaction to take place, which creates columns and an interconnected web within the first layer. In some embodiments, the porous structure of the first layer has pore sizes of 2 nm and 100 nm. Pore size refers to voids created between particles or a result of several particle agglomerations, and can be measured using any suitable technique known in the art, including SEM cross-section. In one embodiment, the first layer is mesoporous. As used herein, in certain embodiments, mesoporous refers to a material containing pores with diameters between 2 nm and 100 nm. In other embodiments, mesoporous refers to a material containing pores with diameters between 2 nm and 50 nm.

### Additional Layers

As described in the methods herein, one or more additional layers are formed over and/or incorporated into the first layer to form a multi-layered porous coating over the conductive material. In some embodiments, after the coating the conductive surface with the first layer described above, the method further includes: forming a second photocatalytic dispersion made up of second photocatalytic particles and a second dispersion medium; and coating the second photocatalytic dispersion onto the first layer, in which at least a portion of the second photocatalytic particles penetrate or partially penetrate the pores in the structure of the first layer. In some variations, the method may further include: forming a third photocatalytic dispersion made up of third photocatalytic particles and a third dispersion medium; and coating the third photocatalytic dispersion onto the second and/or first layer, in which at least a portion of the third photocatalytic particles penetrate or partially penetrate the pores in the structure of the first layer.

In certain embodiments of the methods herein, one additional layer may be formed over the first layer to form a two-layered porous coating over the conductive material. Such a second layer may be formed by partial additions of the second photocatalytic dispersion onto the first layer. Such partial additions may allow the second layer to more fully penetrate the first layer, thereby former a denser structure. In one variation, the method includes: coating a conductive surface with a first layer as described above; combining a plurality of second photocatalytic particles and a second dispersion medium to form a second photocatalytic dispersion; and coating the first layer with a second layer, wherein the second layer is formed by successively coating the first layer with portions of the second photocatalytic dispersion.

“Penetration” generally refers to pore filling. For example, a photocatalytic dispersion may penetrate an existing layer by soaking of the existing layer with photocatalytic particles. A second layer may penetrate a first layer when the second layer is absorbed into the first layer. The second layer may fully or partially penetrate the first layer.

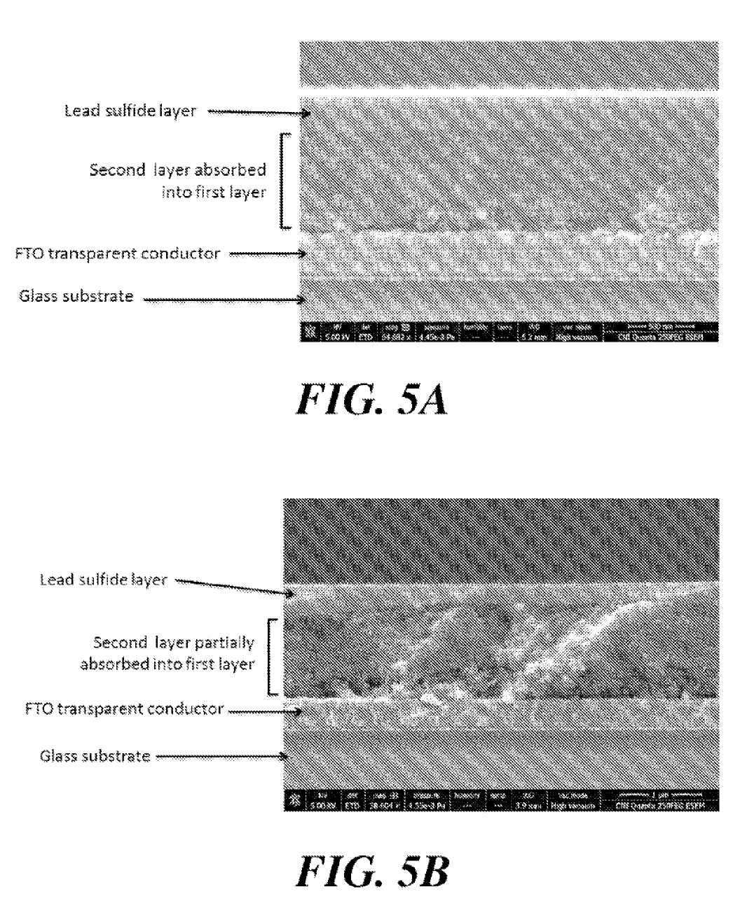

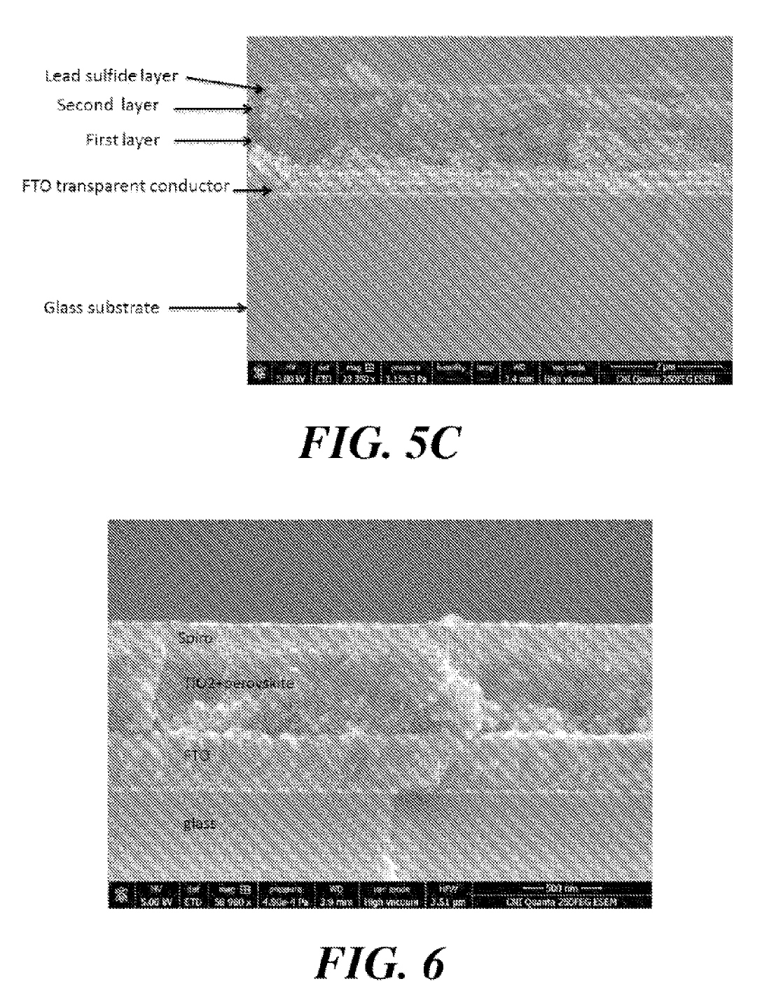

With reference to FIG. 5A, provided is an exemplary SEM image depicting full penetration of the second layer into the first layer. In this exemplary image, a second layer is observed to be fully absorbed into the first layer. When the second layer is fully absorbed (or fully soaks) into the first layer, a denser structure is obtained. With reference to FIG. 5B, provided is an exemplary SEM image depicting partial penetration of the second layer into the first layer. In this exemplary image, a second layer is observed to be partially absorbed into the first layer. With reference to FIG. 5C, provided is an exemplary SEM image depicting little or no penetration of the second layer into the first layer. In this exemplary image, the first and second layers are separately visible, as the second layer remains on top of the first layer.

It should be understood that the SEM images of FIGS. 5A-5C depict cross-sections of exemplary two-layer mesoporous structures with a lead sulfide (PbS) absorber layer, wherein such mesoporous structure is coated onto a FTO surface. Such two-layer mesoporous structure may be prepared according to any suitable methods described herein, including for example the procedure of Example 1 below. Further, a lead sulfide absorber layer may be incorporated using any suitable methods described herein, including for example the procedure of Example 3 below. It should further be understood that although a PbS absorber layer is depicted in FIGS. 5A-5C, other types of absorbers may be incorporated into the mesoporous structure, including, for example, perovskite. Such additional types of absorbers are described in further detail below.

In certain embodiments, at least 50%, 60%, 70%, 80%, 90%, 95%, 99%, or 100% of the pores in the structure of the first layer are filled by the photocatalytic particles of the one or more additional layers. For example, in one embodiment, at least 50%, 60%, 70%, 80%, 90%, 95%, 99%, or 100% of the pores in the structure of the first layer are filled by the photocatalytic particles of the second layer.

It should further be understood that the penetration of the one or more additional layers, including for example the second layer (which may, in certain instances, be made up of smaller particles) into the first layer may create a denser structure that was previously only achieved at higher temperatures where particle sintering occurred. When the methods of the present invention are employed (e.g., using the types of particles and/or binders described herein), the second layer unexpectedly penetrates the first layer to yield a denser structure with higher electrical conductance that is formed without particle sintering. High electrical conductance may be achieved when the particles of second layer penetrate the first layer, and as a result, the particles of the two layers are in closer contact.

In some embodiments, the one or more additional photocatalytic dispersions (e.g., the second photocatalytic dispersion) does not include the use of any of the binders described above for the first photocatalytic dispersion.

The one or more additional photocatalytic dispersions (e.g., the second photocatalytic dispersion) may be formed by applying the photocatalytic particles and dispersion medium to a media mill such as ball mill, or any other appropriate stirring or dispersing device to disperse the photocatalytic particles in the medium used.

The additional photocatalytic dispersions (e.g., the second photocatalytic dispersion) can be coated over the first layer using any techniques known in the art. It should be understood that the coating method can depend on various factors, including the type of particles used.

In some embodiments, the multi-layered porous structure that is coated over the conductive surface is a two-layered porous structure. In one embodiment of the two-layered porous structure, the thickness of the first layer is between 5 and 600 nm, and the second layer may be about 300 nm. It should be understood, however, that the thickness of the second layer may be difficult to determine since the second layer penetrates or partially penetrates at least a portion of the first layer. As used herein, the thickness of the first layer refers to the average distance between the conductive surface/first layer interface and the first layer/second layer interface. The thickness of the second layer refers to the average distance between the first layer/second layer interface and the top of the second layer.

### Photocatalytic Particles

The photocatalytic particles used in the first layer and the one or more additional layers (e.g., second layer) may be any semiconductive oxide particles. For example, the photocatalytic particles may be titanium dioxide (TiO₂) particles, zirconium dioxide (ZrO₂) particles or zinc oxide (ZnO) particles. A combination of different types of particles may also be used. In one embodiment, the photocatalytic particles are titanium dioxide particles.

It should be understood that the particles in the first and one or more additional layers (e.g., second layer) may be the same or different types of particles. For example, in certain embodiments, the photocatalytic particles in both the first and second layers may be titanium dioxide particles. In other embodiments, the photocatalytic particles in the first layer may be the photocatalytic particles, whereas the photocatalytic particles may be zinc oxide particles.

Selection of the particles used in the first layer may depend on various factors, including, for example, whether the particles can be easily agglomerated and de-agglomerated (e.g., by changing the pH or the presence of a solvent that can be selectively evaporated), whether the particles can be readily dispersed in a given binder and solvent system, and whether the particles create clusters and voids upon drying into a porous film. Selection of the particles used in one or more additional layers (e.g., second layer) may likewise depend on various factors, including, for example, whether the particles are well dispersed individual particles or cluster to fit into the voids of the first layer, whether the particles are dispersed in a low surface tension fluid that can flow into the first layer, whether the particles have a surface property, for example, clean, defect-free or low-defect surface with no foreign material (e.g., artifacts of the synthesis process such as organic ligands) that enables them to make electrical contact with each other upon drying, and whether the particles are compatible with, and do not retract from, the particles of the first layer.

The photocatalytic particles used may have varying shapes (including, for example, spheres, rods, cubes, disks, pyramids, prisms, and ovoids) and sizes. In some embodiments, the photocatalytic particles are spheres. The particle size of a spherical particle is the diameter of the particle. In other embodiments, the photocatalytic particles are rods. The particle size of non-spherical particles refers to the radius of revolution in which the entire non-spherical particle would fit.

In some embodiments, the photocatalytic particles used in the first layer have an average particle size between 8 nm and 250 nm, between 8 nm and 200 nm, between 8 nm and 150 nm, between 8-10 nm, between 8-30 nm, between 20 and 250 nm, between 20 nm and 200 nm, between 20 nm and 100 nm, or between 20 nm and 50 nm; or about 20 nm, about 30 nm, about 40 nm, about 50 nm, about 75 nm or about 100 nm.

In other embodiments, at least 20%, 30%, 40%, 50%, 60%, 70%, 80%, 90% or 95% of the photocatalytic particles used in the first layer have a particle size between 10 nm and 250 nm, between 10 nm and 200 nm, between 10 nm and 150 nm, between 20 and 250 nm, between 20 nm and 200 nm, between 20 nm and 100 nm, or between 20 nm and 50 nm; or about 20 nm, about 30 nm, about 40 nm, about 50 nm, about 75 nm or about 100 nm.

In some embodiments, the photocatalytic particles used in the one or more additional layers (e.g., the second layer) have an average particle size less than the average particle size of the photocatalytic particles used in the first layer.

In certain embodiments, the photocatalytic particles used in the one or more additional layers (e.g., the second layer) have an average particle size between 5 nm and 50 nm, between 5 nm and 40 nm, between 5 nm and 30 nm, between 5 nm and 20, between 5 nm and 15 nm, between 5 nm and 10 nm, or between 10 nm and 20 nm, or about 5 nm, about 10 nm, about 15 nm, about 20 nm, or about 25 nm.

In yet other embodiments, at least 20%, 30%, 40%, 50%, 60%, 70%, 80%, 90% or 95% of the photocatalytic particles used in the one or more additional layers (e.g., the second layer) have a particle size between 5 nm and 50 nm, between 5 nm and 40 nm, between 5 nm and 30 nm, between 5 nm and 20, between 5 nm and 15 nm, between 5 nm and 10 nm, or between 10 nm and 20 nm, or about 5 nm, about 10 nm, about 15 nm, about 20 nm, or about 25 nm.

In one embodiment, the photocatalytic particles in the first layer is between 20 nm and 30 nm, and the photocatalytic particles in the one or more additional layers (e.g., the second layer) is between 5 nm and 15 nm. In certain embodiments, the ratio of the average size of the particles in the first layer to the average size of the particles in the one or more additional layers is about 2:1.

### Binders

The binder may be any material suitable for outdoor coating or paint, for example. For example, the binder may be a polymeric binder. In some embodiments, the binder is a resin, a rubber, or an elastomer. A combination of binders may be used. For example, a combination of resins can be used, as well as a combination of rubbers, a combination of elastomers, or a combination of resins, rubbers, or elastomers may be used. Suitable resins may include, for example, thermoplastic resins or thermosetting resins. Suitable rubbers may include natural or synthetic rubbers. Suitable elastomers may include, for example, polybutadiene. In some embodiments, the binder is a polyacrylate, a polythiophene, a polyvinylalcohol, or any combinations thereof. In one embodiment, the binder is a polyacrylate, or a mixture of polyacrylates. In another embodiment, the binder is a polyvinylalcohol. One of skill in the art would recognize that polyvinylalcohols can provide a wide range of crosslinking capabilities and are compatible with inorganic oxides such as titanium dioxide.

Suitable binders may include, for example, Neocryl® BT-67 (NeoResins), poly(3-hexylthiophene-2,5-diyl) (P3HT, Merck), poly(3,4-ethylenedioxythiophene) (PEDOT, Clevios PH500 HC Stark), polyvinyl alcohol (PVA)-methylmethacrylate (MMA) copolymer (Elvanol® 75-15, Dupont), co-solvent-free aliphatic urethane (NeoRez® R9630, DSM), aliphatic urethanes (NeoRez® R9603 and NeoRez® R972 fromDSM), aliphatic urethane acrylic (Neopac® R9045, DSM), polycarbonate aliphatic urethane/acrylic (Neopac® R9036, DSM), and aliphatic polycarbonate polyurethanes (RU-21-075, RU-40-415, and RU-13-442, from Stahl). Other binders may be inorganic binders. Such inorganic binders may include metal peroxides (e.g., PING (PURETi)).

Selection of binders used may depend on various factors, including compatibility with the type of photocatalytic particles used, hydrophilicity, surface energy, and pH of the dispersion. In some embodiments, the binders selected for use in the methods described herein may have one or more of the following properties:

(i) the binders do not cause agglomeration or formation of agglomeration deposits of the particles;

(ii) the binders form a stable dispersion, such as a dispersion that does not readily settle or agglomerate over time (e.g., a few days); and

(iii) the binders display edge effects, such as an irregular shaped boundary between coated and uncoated areas.

The relative amounts of photocatalytic particles to the binder (e.g., polymeric binder) used can impact the overall efficiency and lifetime of PV devices. The relative amount of photocatalytic particles to binder (e.g., polymeric binder) may vary depending on the type, size and/or shape of the photocatalytic particles used. Such ratio of photocatalytic particles to binder (e.g., polymeric binder) may be expressed a “pigment volume concentration” (PVC), which refers to the volume fraction of the photocatalytic particles to the binder. For example, it was unexpectedly observed that for titanium dioxide particles having an average particle size of about 20 nm, a ratio of photocatalytic particles to binder (e.g., polymeric binder) between 0.36 and 0.45, or between 0.38 and 0.42 (such ratio expressed as the PVC) yielded optimal performance.

Without wishing to be bound by any theory, when the ratio of photocatalytic particles to binder (e.g., polymeric binder) is below 0.36 (such ratio expressed as the PVC), an excess of binder may be present that can insulate the particles and restrict electrical conduction between particles. Moreover, when the ratio of photocatalytic particles to binder (e.g., polymeric binder) is above 0.65 (such ratio expressed as the PVC), not enough binder may be present to give the particles the mechanical stability to hold together and form a mechanically robust, long-lasting layer.

### Dispersion Medium

The dispersion medium used in the methods described herein may be any liquid that does not cause agglomeration of the particles and or chemically react with the binder. A combination or mixture of dispersion medium may be used. The dispersion medium may be an organic solvent. The dispersion medium, when combined with the photocatalytic particles and binder (as in the case of the first layer) or with the photocatalytic particles (as in the case of the one or more additional layers), may form a solution or an emulsion.

In some embodiments, the dispersion medium includes water. In other embodiments, the dispersion medium includes a compound with one or more functional groups, such as one or more alcohol groups, one or more ether groups, one or more amide groups, one or more ketone groups, one or more aliphatic groups, one or more halide groups, or one or more ester groups. For example, in certain embodiments, the compound may have two alcohols groups (e.g., glycols), or the compound may have two alcohol groups and an ether group (e.g., glycerol monoallyl ether).

In certain embodiments, the dispersion medium includes an alcohol, a glycol, an ether, a glycerol, an amide, a ketone, a hydrocarbon, an aromatic, a silicone oil, a halogenated hydrocarbon, a halide, or an ester. In certain embodiments, the dispersion medium includes water, an alcohol, or a mixture thereof.

Examples of suitable dispersion medium may include water, alkyl alcohols (e.g., methyl alcohol, ethyl alcohol, isopropyl alcohol, butyl alcohol), alkylene alcohols (e.g., allyl alcohol), glycols (e.g., ethylene glycol, propylene glycol, diethylene glycol, polyethylene glycol, polypropylene glycol), ethers (e.g., diethylene glycolmonoethyl ether, polypropylene glycol monoethyl ether, polyethylene glycol monoallyl ether, polypropylene glycol monoallyl ether, glycerol, glycerol monoethyl ether, glycerol monoallyl ether, tetrahydrofuran, dioxane), ketones (e.g., N-methylpyrrolidone, methyl ethyl ketone, methyl isobutyl ketone), alkanes (e.g., liquid paraffin, decane, hexane, cyclohexane), alkenes (e.g., decene, decalin, kerosene), aromatics (e.g., methyl naphthalene, diphenyl methane, toluene, dimethyl benzene, ethyl benzene, diethyl benzene, propyl benzene, partially hydrogenated biphenyl, chlorobenzene, dichlorobenzene, bromobenzene, chlorodiphenyl, chlorodiphenyl methane, ethyl benzoate, octyl benzoate, dioctyl phthalate, trioctyl trimellitate, xylene), siloxanes (e.g., polydimethyl siloxanes, partially octyl-substituted polydimethyl siloxane, partially phenyl-substituted polydimethyl siloxane), silicon oil (e.g., fluorosilicone oil), halides (e.g., fluoride), esters (e.g., dibutyl sebacate), acrylates (e.g., ethyl(meth)acrylate, butyl(meth)acrylate, dodecyl (meth)acrylate), or any combinations thereof.

The selection of the dispersion medium used may depend on various factors, including the type of binder used (as in the case of the first layer) and the type of photocatalytic particles used. For example, with respect to the first layer, when rubbers and/or thermoplastics are used as the binder, aromatic solvents may be used as the dispersion medium. In another example, when polyvinyl alcohols are used as the binder, water may be a suitable dispersion medium. In yet another example, when acrylics are used as the binder, alcohols or halogenated solvents (including chlorinated solvents, such as chloroform) may be used.

The amount of dispersion medium used may vary for the first layer compared to the one or more additional layers. For example, with respect to the one or more additional layers (e.g., the second layer), the one or more additional dispersions (e.g., the second photocatalytic dispersion) has a solids content of at least 0.1%, 1%, 2%, 3%, 4%, 5%, 10%, 20%, or 35%.

In some embodiments, the dispersion medium used for the first layer may be the same or different as the one or more additional layers. Additionally, in other embodiments, the dispersion medium used for the one or more additional layers may be the same or different.

### P-Type Absorbers

In some aspects of the methods described herein, the method further includes incorporating P-type absorbers into (e.g., by coating onto and/or depositing into) the multi-layer porous structure to obtain different PV cell configurations and different performance characteristics, such as color, transparency and power density.

In some embodiments, the absorber is a material that absorbs light and generates electrons as a result of that absorption, and such generated electrons can be extracted to create useful power or energy. Extraction can be accomplished by placing the absorber next to an electron acceptor, such as TiO₂, that can absorb the electron.

Selection of the type of absorbers used in the methods described herein may depend on various factors, including, for example, the type of photocatalytic particles used. For example, absorbers suitable for electron extraction by TiO₂ are materials that have a conduction band energy level close enough to and below that of TiO₂ to transfer the electron to the conduction band of TiO₂. In certain embodiments, where the photocatalytic particles are titanium dioxide particles, the absorber may include any material that has a conduction band energy level between about −4.2 eV to about −3 eV.

Suitable P-type absorbers for use in the methods described herein include, for example, perovskite (e.g., PbI-based perovskite), copper indium sulfide (CIS), copper zinc tin sulfide (CZTS), chloroindium phthalocyanine (ClInPc), lead sulfide (PbS), polyoctylthiophene (P3OT), polyhexylthiophene (P3HT), tungsten disulfide (WS2), copper oxide (Cu₂O, CuO), molybdeum disulfide (MoS₂), carbon nanotubes (CNT), and copper bismuth sulfide (Cu₄Bi₉S₉). A combination of P-type absorbers may also be used.

Any suitable methods known in the art may be used to incorporate the absorbers into the multi-layer structure. One of skill in the art would recognize that the methods to incorporate such absorbers may differ depending on the type of absorber used. For example, in one embodiment, the absorber is lead sulfide, which may be coated onto a mesoporous structure by any suitable methods or techniques known in the art.

In another embodiment, the P-type absorber is perovskite, which may be incorporated by depositing perovskite precursors into the mesoporous structure, and the precursors can react to generate perovskite in situ. Suitable perovskite precursors include, for example, PbI₂ and CH₃NH₃I IPA, which react to form a perovskite. One of skill in the art would recognize the various ways in which perovskite as an absorber may be incorporated into the multi-layer porous (e.g., mesoporous) structure. When the perovskite precursors described above are used in the methods herein, a one or two-step method may be employed to incorporate perovskite into a mesoporous structure. For example, a CH₃NH₃PbI₃ solution may be spin coated directly on top of a mesoporous structure; in another example, a PbI₂ layer may be spin coated on top of the mesoporous TiO₂ layer, then the PbI₂ layer may be dipped into the CH₃NH₃I IPA solution in order to convert PbI₂ to CH₃NH₃PbI₃ perovskite. See e.g., Nature Photonics, 2013, 7, 486; Nature, 2013, 499, 316.

### Hole Conducting Layer

In some embodiments of the methods described herein, the method further includes coating the absorber layer (or coating the mesoporous structure with an absorber layer deposited within) with a hole conducting layer. The hole conducting material is in contact with the absorber layer described above, and serves as an interface between the absorber and top electrode. Any suitable hole conducting materials known in the art may be used, including for example of 2,2′,7,7′-tetrakis[N,N-di(4-methoxyphenyl)amino]-9,9′-spirobifluorene (spiro-OMeTAD), and poly(3,4-ethylenedioxythiophene) (PEDOT).

Conductive Surface Coated with Multi-Layer Mesoporous Structure

In some examples, the multi-layer coated conductive surfaces described may have a resistance of 5-100Ω/□ and a transmission of 70-95% from 300-1000 nm wavelength of light.

In some examples, the multi-layer coated conductive surfaces may be used in touch screen panels, LCD displays, Window defoggers, and PV cells.

### Systems

Provided herein is also a system that includes:

a substrate with a conductive surface; and

a porous structure made up of a first photocatalytic layer and a second photocatalytic layer, wherein:
the first photocatalytic layer includes first photocatalytic particles and binder, and the first photocatalytic layer is coated on the conductive surface of the substrate;
the second photocatalytic layer includes second photocatalytic particles, and wherein the second photocatalytic layer penetrates or partially penetrates the first photocatalytic layer.

The substrate may, for example, be a glass substrate. The substrate may be coated with a conductive film to obtain the conductive surface. For example, the substrate may be coated with indium tin oxide (ITO) or a halogenated tin oxide, such as fluorinated tin oxide (FTO).

In some embodiments, the porous structure may be a mesoporous structure. In one variation, the porous structure has pore sizes with diameters between 2 nm and 100 nm, or between 2 and 50 nm.

The photocatalytic particles present in the system may include any of the photocatalytic particles described herein. For example, the first or second photocatalytic layers may include semiconductive oxide particles. In some embodiments, the photocatalytic particles may be selected from titanium dioxide particles, zirconium dioxide particles, and zinc oxide particles, or any combination thereof.

The binder present in the system may include any of the binders described herein. The binder may be a polymeric bind. For example, the binder may be any suitable resin, rubber, or elastomer. In some embodiments, the binder is polyacrylate, polythiophene, polyvinylalcohol, or any combinations thereof.

The first and second layers may, in certain embodiments, have the same types of particles; and in other embodiments, different types of particles. In certain embodiments, the average particle size of the second photocatalytic particles is less than the average particle size of the plurality of first photocatalytic particles. For example, in one variation, the first photocatalytic particles have an average particle size between 8 nm and 10 nm; and the second photocatalytic particles have an average particle size between 5 nm and 50 nm. When the second photocatalytic particles have a smaller particle size, such particles can more effectively penetrate into the pores of the first layer.

In some embodiments, the system further includes: an absorber layer, wherein the absorber layer is coated on or deposited into the porous structure. In certain embodiments, the absorber layer includes P-type material. In one variation, the absorber layer includes perovskite (e.g., PbI-based Perovskite), copper indium sulfide (CIS), copper zinc tin sulfide (CZTS), chloroindium phthalocyanine (ClInPc), lead sulfide (PbS), polyoctylthiophene (P3OT), polyhexylthiophene (P3HT), tungsten disulfide (WS2), copper oxide (Cu₂O, CuO), molybdeum disulfide (MoS₂), carbon nanotubes (CNT), or copper bismuth sulfide (Cu₄Bi₉S₉), or any combinations thereof. For example, when the absorber layer includes perovskite, such perovskite may be deposited into the porous structure. In another example, when the absorber layer includes lead sulfide, such lead sulfide may coated onto the porous structure.

In certain aspects, provided is a system that includes:

(1) a substrate with an indium tin oxide or fluorinated tin oxide surface; and

(ii) a mesoporous structure made up of a first photocatalytic layer and a second photocatalytic layer, wherein:
the first photocatalytic layer is coated on the conductive surface of the glass substrate;
the first photocatalytic layer includes first photocatalytic particles and binder, wherein:
   the first photocatalytic particles are titanium dioxide particles, and
   the polymeric binder is polyacrylate, polythiophene, polyvinylalcohol, or any combinations thereof;
the second photocatalytic layer penetrates or partially penetrates the first photocatalytic layer;
the second photocatalytic layer includes second photocatalytic particles, wherein:
   the second photocatalytic particles are titanium dioxide particles; and

(iii) a P-type absorber layer.

In some embodiments, the absorber layer includes perovskite. In other embodiments, the absorber layer includes lead sulfide.

In other embodiments, the system further includes a hole conducting layer.

Reference to “between” two values or parameters herein includes (and describes) embodiments that include the stated value or parameter per se. For example, description referring to “between x and y” includes description of “x” and “y”.

### Enumerated Embodiments

The following enumerated embodiments are representative of some aspects of the invention.

1. A method of coating a conductive surface with a multi-layer mesoporous structure, comprising:

a) combining a plurality of first photocatalytic particles, polymeric binder and a first dispersion medium to form a first photocatalytic dispersion;

b) coating a conductive surface with the first photocatalytic dispersion to form a first layer over the conductive surface;

c) curing or partially curing the first layer at a temperature of less than 200° C. to form a porous first layer;

d) combining a plurality of second photocatalytic particles and a second dispersion medium to form a second photocatalytic dispersion; and

e) coating the porous first layer with the second photocatalytic dispersion to form a second layer over the porous first layer, wherein the formation of second layer over the porous first layer produces a conductive surface coated with a multi-layer mesoporous structure.

2. The method of embodiment 1, wherein the ratio of the amount of first photocatalytic particles to the amount of polymeric binder present in the first photocatalytic dispersion is 0.36 to 0.65.
3. The method of embodiment 2, wherein the ratio of the amount of first photocatalytic particles to the amount of polymeric binder present in the first photocatalytic dispersion is 0.38 to 0.42.
4. The method of any one of embodiments 1 to 3, wherein at least 30% of each first photocatalytic particle in the porous first layer is coated with the polymeric binder.
5. The method of any one of embodiments 1 to 4, wherein the conductive surface is an indium tin oxide or fluorinated tin oxide surface.
6. The method of any one of embodiments 1 to 5, wherein the multi-layered mesoporous structure is a two-layered mesoporous structure.
7. The method of any one of embodiments 1 to 6, wherein the first photocatalytic particles and the photocatalytic particles are each independently semiconductive oxide particles.
8. The method of embodiment 4, wherein the first photocatalytic particles and the second photocatalytic particles are each independently titanium dioxide particles, zirconium dioxide particles, zinc oxide particles, or any combination thereof.
9. The method of any one of embodiments 1 to 8, wherein the average particle size of the plurality of second photocatalytic particles is less than the average particle size of the plurality of first photocatalytic particles.
10. The method of any one of embodiments 1 to 8, wherein the plurality of first photocatalytic particles has an average particle size between 8 nm and 10 nm.
11. The method of any one of embodiments 1 to 8, wherein the plurality of first photocatalytic particles has an average particle size between 10 nm and 250 nm.
12. The method of embodiment 6, wherein the plurality of first photocatalytic particles has an average particle size between 20 nm and 100 nm.
13. The method of embodiment 12, wherein the plurality of first photocatalytic particles has an average particle size between 20 nm and 40 nm.
14. The method of any one of embodiments 1 to 13, wherein the plurality of second photocatalytic particles has an average particle size between 5 nm and 50 nm.
15. The method of embodiment 6, wherein the plurality of second photocatalytic particles has an average particle size between 5 nm and 15 nm.
16. The method of any one of embodiments 1 to 15, wherein the polymeric binder is a resin, a rubber, an elastomer, or any combinations thereof.
17. The method of any one of embodiments 1 to 8, wherein the polymeric binder is thermoplastic resin, thermosetting resin, natural rubber, synthetic rubber, elastomer, or any combinations thereof.
18. The method of any one of embodiments 1 to 8, wherein the polymeric binder comprises polyacrylate, polythiophene, polyvinylalcohol, or any combinations thereof.
19. The method of any one of embodiments 1 to 8, wherein the polymeric binder comprises metal peroxide.
20. The method of any one of embodiments 1 to 19, wherein the first dispersion medium and the second dispersion medium each independently comprises water, an alcohol, a glycol, an ether, a glycerol, an amide, a ketone, a hydrocarbon, an aromatic, a silicone oil, a halogenated hydrocarbon, a halide, an ester, or any combinations thereof.
21. The method of any one of embodiments 1 to 19, wherein the first dispersion medium and the second dispersion medium each independently comprises water, an alcohol, or a mixture thereof.
22. The method of any one of embodiments 1 to 19, wherein the first dispersion medium and the dispersion medium each independently comprises water, methyl alcohol, ethyl alcohol, isopropyl alcohol, butyl alcohol, allyl alcohol, ethylene glycol, propylene glycol, diethylene glycol, polyethylene glycol, polypropylene glycol, diethylene glycolmonoethyl ether, polypropylene glycol monoethyl ether, polyethylene glycol monoallyl ether, polypropylene glycol monoallyl ether, glycerol, glycerol monoethyl ether, glycerol monoallyl ether, N-methylpyrrolidone, tetrahydrofuran, dioxane, methyl ethyl ketone, methyl isobutyl ketone, liquid paraffin, decane, decene, methyl naphthalene, decalin, kerosene, diphenyl methane, toluene, dimethyl benzene, ethyl benzene, diethyl benzene, propyl benzene, cyclohexane, partially hydrogenated triphenyl, polydimethyl siloxanes, partially octyl-substituted polydimethyl siloxane, partially phenyl-substituted polydimethyl siloxane, fluorosilicone chlorobenzene, dichlorobenzene, bromobenzene, chlorodiphenyl, chlorodiphenyl methane, fluoride, el yl benzoate, octyl benzoate, dioctyl phthalate, trioctyl trimellitate, dibutyl sebacate, ethyl(meth)acrylate, butyl(meth)acrylate, dodecyl (meth)acrylate, xylene, hexane, or any combinations thereof.
23. The method of any one of embodiments 1 to 22, wherein the first photocatalytic dispersion and the second photocatalytic dispersion are each independently a solution or emulsion.
24. The method of any one of embodiments 1 to 23, wherein the first layer is cured or partially cured at a temperature of between 100° C. and 150° C.
25. The method of any one of embodiments 1 to 23, wherein the first layer is cured or partially cured at a temperature of less than 130° C.
26. The method of any one of embodiments 1 to 25, wherein the porous first layer is a mesoporous first layer.
27. The method of any one of embodiments 1 to 26, wherein at least a portion of the second photocatalytic dispersion penetrates or partially penetrates at least a portion of the pores in the porous first layer.
28. The method of any one of embodiments 1 to 27, further comprising:

combining a plurality of third photocatalytic particles and a third dispersion medium to form a third photocatalytic dispersion; and

coating the second layer with the third photocatalytic dispersion to form a third layer over the second layer.

29. The method of embodiment 28, wherein the average particle size of the plurality of third photocatalytic particles is less than the average particle size of the plurality of first photocatalytic particles.

30. The method of embodiment 28 or 29, wherein the plurality of third photocatalytic particles has an average particle size between 5 nm and 50 nm.
31. The method of any one of embodiments 1 to 30, further comprising coating the multi-layer mesoporous structure of conductive surface with a P-type material.
32. The method of embodiment 31, wherein the P-type material is perovskite.
33. The method of embodiment 32, wherein less than 1% of the P-type material penetrates the multi-layer mesoporous structure of the conductive surface to create a bilayer P-N heterojunction.
34. The method of any one of embodiments 1 to 33, wherein the photocatalytic type semiconductive particles comprise wide band gap N-type semiconductive particles.
35. A method of coating a conductive surface with a multi-layer mesoporous structure, comprising:

a) combining a plurality of first N-type semiconductive particles, polymeric binder and a first dispersion medium to form a first semiconductive dispersion;

b) coating a conductive surface with the first semiconductive dispersion to form a first layer over the conductive surface;

c) curing or partially curing the first layer at a temperature of less than 200° C. to form a porous first layer;

d) combining a plurality of second N-type semiconductive particles and a second dispersion medium to form a second semiconductive dispersion; and

e) coating the porous first layer with the second semiconductive dispersion to form a second layer over the porous first layer, wherein the formation of second layer over the porous first layer produces a conductive surface coated with a multi-layer semiconductive structure.

36. The method of embodiment 35, wherein the N-type semiconductive particles comprise wide band gap N-type semiconductive particles.
37. The method of embodiment 36, wherein the first layer is cured or partially cured at a temperature of less than 130° C.
38. The method of embodiment 36, wherein the first layer is cured or partially cured at a temperature of between 100° C. and 150° C.
39. A conductive surface coated with a multi-layer mesoporous structure according to the method of any one of embodiments 1 to 37.
40. A system comprising:

a substrate with a conductive surface; and

a porous structure made up of a first photocatalytic layer and a second photocatalytic layer, wherein:
the first photocatalytic layer includes first photocatalytic particles and binder, and the first photocatalytic layer is coated on the conductive surface of the substrate;
the second photocatalytic layer includes second photocatalytic particles, and wherein the second photocatalytic layer penetrates or partially penetrates the first photocatalytic layer.
   41. The system of embodiment 40, wherein the substrate is a glass substrate.
   42. The system of embodiment 40 or 41, wherein the conductive surface is a conductive film coated onto the surface of the substrate.
   43. The system of embodiment 42, wherein the conductive film comprises indium tin oxide (ITO) or fluorinated tin oxide (FTO), or a combination thereof.
   44. The system of any one of embodiments 40 to 43, wherein the porous structure is a mesoporous structure.
   45. The system of any one of embodiments 40 to 43, wherein the porous structure has pore sizes with diameters between 2 nm and 100 nm.
   46. The system of embodiment 45, wherein the porous structure has pore sizes with diameters between 2 and 50 nm.
   47. The system of any one of embodiments 40 to 46, wherein the first photocatalytic particles and the second photocatalytic particles are each independently semiconductive oxide particles.
   48. The system of any one of embodiments 40 to 46, wherein the first photocatalytic particles and the second photocatalytic particles are each independently titanium dioxide particles, zirconium dioxide particles, zinc oxide particles, or any combination thereof.
   49. The system of any one of embodiments 40 to 48, wherein the average particle size of the second photocatalytic particles is less than the average particle size of the first photocatalytic particles.
   50. The system of any one of embodiments 40 to 48, wherein the first photocatalytic particles has an average particle size between 8 nm and 10 nm.
   51. The system of embodiment 50, wherein the first photocatalytic particles has an average particle size between 10 nm and 250 nm.
   52. The system of embodiment 51, wherein the first photocatalytic particles has an average particle size between 20 nm and 100 nm.
   53. The system of embodiment 52, wherein the first photocatalytic particles has an average particle size between 20 nm and 40 nm.
   54. The system of any one of embodiments 40 to 53, wherein the second photocatalytic particles has an average particle size between 5 nm and 50 nm.
   55. The system of embodiment 54, wherein the second photocatalytic particles has an average particle size between 5 nm and 15 nm.
   56. The system of any one of embodiments 40 to 55, wherein the binder is resin, rubber, or elastomer.
   57. The system of any one of embodiments 40 to 55, wherein binder is polyacrylate, polythiophene, polyvinylalcohol, or any combinations thereof.
   58. The system of any one of embodiments 40 to 55, wherein the binder is a thermoplastic resin, a thermosetting resin, a natural rubber, a synthetic rubber, an elastomer, or any combinations thereof.
   59. The system of any one of embodiments 40 to 55, wherein the binder comprises polyacrylate, polythiophene, polyvinylalcohol, or any combinations thereof.
   60. The system of any one of embodiments 40 to 55, wherein the binder comprises metal peroxide.
   61. The system of any one of embodiments 40 to 60, further comprising an absorber layer.
   62. The system of embodiment 61, wherein the absorber layer comprises a P-type material.
   63. The system of embodiment 61, wherein the absorber layer comprises perovskite, copper indium sulfide, copper zinc tin sulfide, chloroindium phthalocyanine, lead sulfide, polyoctylthiophene, polyhexylthiophene, tungsten disulfide, copper oxide, molybdeum disulfide, carbon nanotubes, or copper bismuth sulfide, or any combinations thereof.
   64. The system of embodiment 61, wherein the absorber layer comprises perovskite.
   65. The system of embodiment 64, wherein the absorber layer comprises PbI-based perovskite.
   66. The system of embodiment 61, wherein the absorber layer comprises lead sulfide.
   67. The system of any one of embodiments 40 to 66, further comprising a hole conducting layer, wherein the hole conducting layer is in contact with the absorber layer.
   68. The system of embodiment 67, further comprising an electrode, wherein the electrode is in contact with the hole conducting layer.
   69. A system comprising:

(1) a substrate with an indium tin oxide or fluorinated tin oxide surface; and

(ii) a mesoporous structure made up of a first photocatalytic layer and a second photocatalytic layer, wherein:
the first photocatalytic layer is coated on the conductive surface of the glass substrate;
the first photocatalytic layer includes first photocatalytic particles and binder, wherein:
   the first photocatalytic particles are titanium dioxide particles, and
   the binder is polyacrylate, polythiophene, polyvinylalcohol, or any combinations thereof;
the second photocatalytic layer penetrates or partially penetrates the first photocatalytic layer;
the second photocatalytic layer includes second photocatalytic particles, wherein:
   the second photocatalytic particles are titanium dioxide particles; and

(iii) a P-type absorber layer.

70. The system of embodiment 69, further comprising an absorber layer.
71. The system of embodiment 69, wherein the absorber layer comprises a P-type material.
72. The system of embodiment 69, wherein the absorber layer comprises perovskite, copper indium sulfide, copper zinc tin sulfide, chloroindium phthalocyanine, lead sulfide, polyoctylthiophene, polyhexylthiophene, tungsten disulfide, copper oxide, molybdeum disulfide, carbon nanotubes, or copper bismuth sulfide, or any combinations thereof.
73. The system of embodiment 69, wherein the absorber layer comprises perovskite.
74. The system of embodiment 73, wherein the absorber layer comprises PbI-based perovskite.
75. A system comprising a substrate with a conductive surface coated with a multi-layer mesoporous structure according to the method of any one of embodiments 1 to 39.
76. The system of any one of embodiments 40 to 75, wherein the system is a photovoltaic cell.

### Examples

The following Examples are merely illustrative and are not meant to limit any aspects of the present disclosure in any way.

Units and abbreviations used herein include:

V_{oc}=open circuit voltage;

J_{sc}=short circuit current;

FF=fill factor;

R_{scr}=series resistance;

Rₛₕ=shunt resistance;

PCE=power conversion efficiency;

P3OT=poly 3-octyl thiophene;

OC2SC=open circuit to short circuit;

R_{H}=relative humidity;

Eff=efficiency;

Rs=series resistance; and

IV=current-voltage.

### Example 1

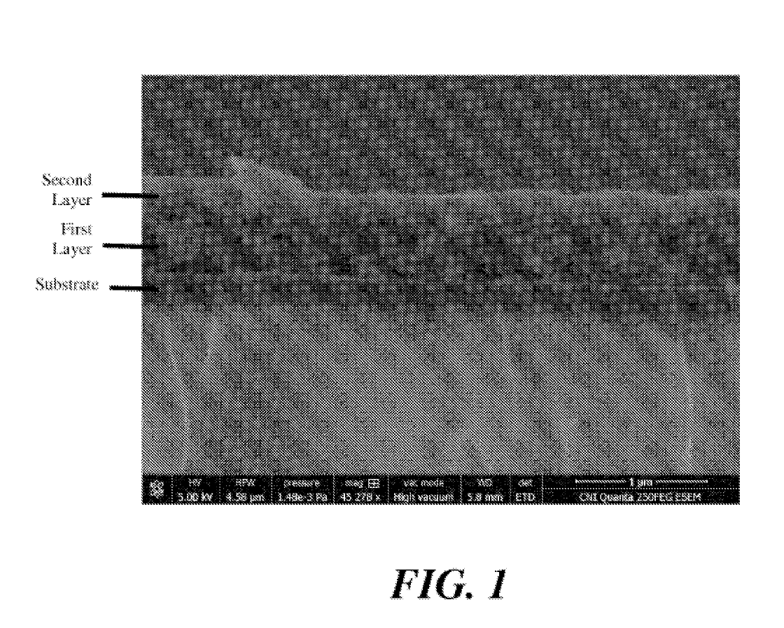

Cross-linkable acrylic binder emulsions from Neoresins (such as BT-67) were selected as the polymeric material and P25 titania powder from Evonik was selected as particle in the first coating. The two materials were added to water at a ratio of roughly 1:1 particles to binder and the mixture was ground in a ball mill for 1 hr. The resulting dispersion was diluted to 5% solids and coated onto an ITO-coated PET to create a 600 nm thick deposited film. The coating was then cured at 125° C. for 5 min. to allow the binder to crosslink. The layer appears as a white translucent coating. The second coating used a solvothermal process to produce titania nanoparticles (e.g., as described in Int. J. Electrochem. Sci., Vol. 7, 2012) that was diluted to 5% solids and coated on top of the first coating. The second layer was observed to absorb into the first layer, making the combination of layers appear window clear. A cross-sectional SEM image of the porous structure formed is provided in FIG. 1.

### Example 2

The coating in Example 1 above was used as the substrate in this Example. A layer of P3HT (Merck) dissolved in xylene was coated on top to create a 200 nm layer. This layer was dried at 125° C. for 2 minutes. This was followed by a 200 nm coating of PEDOT (Clevios PHSO0 HC Stark) and cured in the oven at 125° C. for 15 minutes. The top electrode was then coated (Ag paste Dupont) and dried at 125° C. for 10 minutes. The resultant cell was a red colored semitransparent cells when measured using a Keithly 2400 series SourceMeter and a sun simulator (full-spectrum metal halide-type light source), as described in IEC 61646 PV certification documents, and yielded the results shown in Table 1 below.

TABLE 1

| Example | Voc | JSC | FF | Rser | Rsh | PCE |
|---|---|---|---|---|---|---|
| P-type P3OT | −0.688 | 1.29 | 36.80 | 329 | 1119 | 0.33 |
| P-type PbS | −0.55 | 19.96 | 45.25 | 9 | 5462 | 4.80 |
| P-type PbS | −0.58 | 21.00 | 45.22 | 10 | 2419 | 5.43 |
| High temp TiO₂ | −0.59 | 21.89 | 58.0 | 5 | 9880 | 7.4 |
| control with PbS | | | | | | |

### Example 3

The coating in Example 1 was used as the bottom layer and N-type material. A layer of lead sulfide (PbS) nanoparticles in hexane was coated on top to create a 200 nm P-type absorber layer according to the process described in ACS Nano Vol. 4 No. 6 PP3374-3380. This layer was dried at 125° C. for 2 minutes. This coating was followed by a 20 nm vacuum evaporated layer of Molybdenum Trioxide (M03). The top electrode was deposited by vacuum deposition at a thickness of 100 nm. The resultant cell was a black opaque cell that when measured using a Keithly 2400 series SourceMeter and a sun simulator (full-spectrum metal halide-type light source), as described in IEC 61646 PV certification documents, and yielded the results shown in Table 2 below.

TABLE 2

| | Static | | | | | | | |
|---|---|---|---|---|---|---|---|---|
| | | | Norm | | OC2SC | | | |
| Device | VOC | JSC | Jsc | PCE | Hysteresis | FF | Rser | Rsh |
| Substrate 1, device 1 | −0.55 | 20.56 | 20.40 | 5.04 | 5.19 | 47.28 | 9 | 1846 |
| Substrate 1, device 2 | −0.55 | 19.96 | 19.80 | 4.80 | 6.06 | 45.25 | 9 | 5462 |
| Substrate 2, device 1 | −0.58 | 21.00 | 20.83 | 5.43 | 2.27 | 45.22 | 10 | 2419 |
| Substrate 2, device 2 | −0.57 | 21.89 | 21.72 | | 2.26 | 47.09 | 8 | 6009 |
| Control with high | .6 | 21 | 5.68 | | 5 | 55-60 | 5-6 | 20 K |
| temp TiO₂ | | | | | | | | |

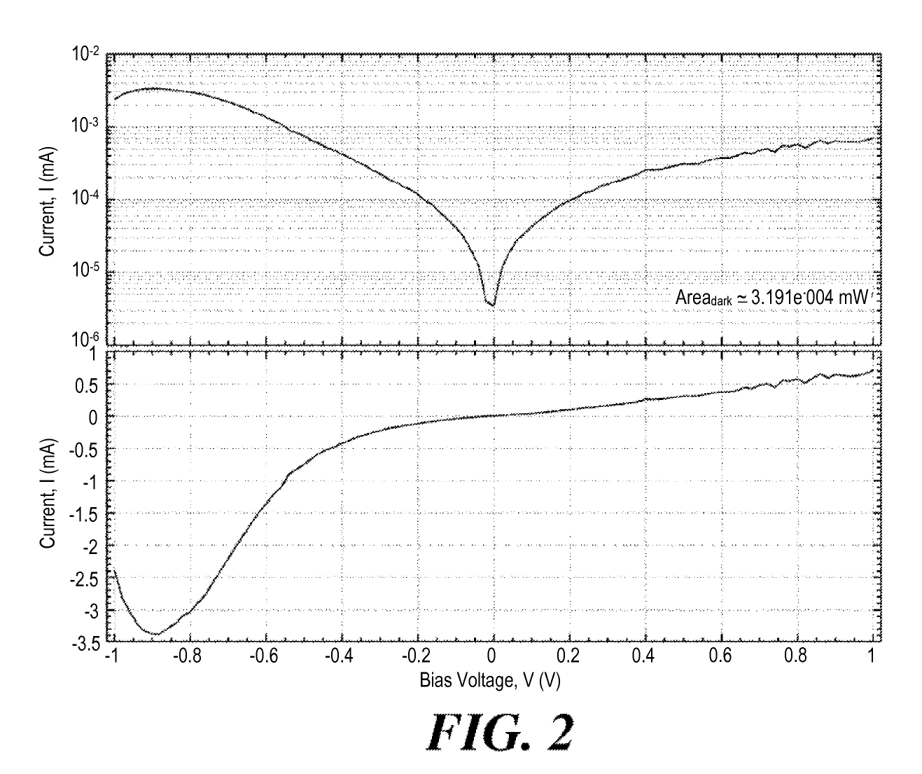

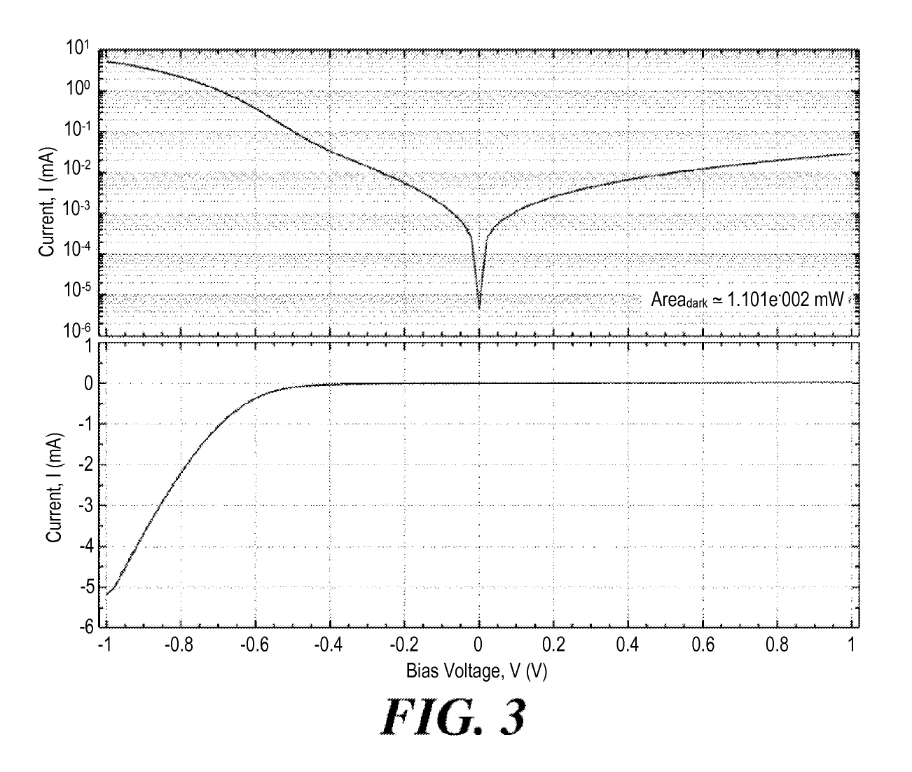

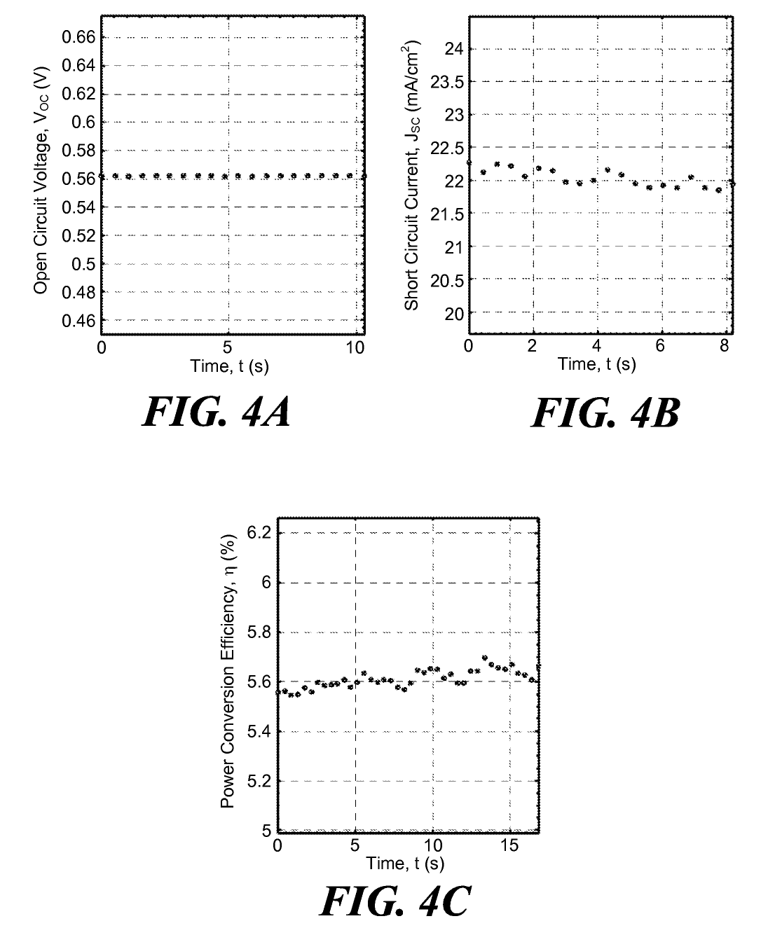

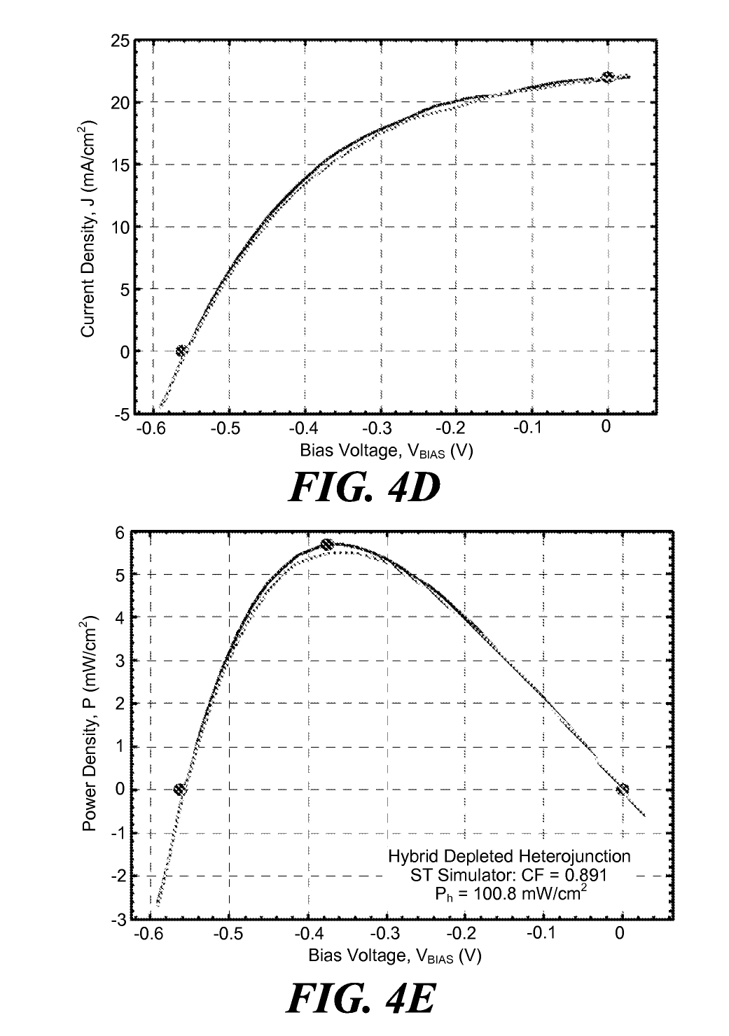

Additionally, FIG. 2 provides a graph depicting a typical dark IV curve of a cell prepared according to the procedure in this Example; FIG. 3 provides a graph depicting typical dark IV curve after light soaking of a cell prepared according to the procedure in this Example; and FIG. 4A-4E provide graphs that depict the cell performance of a lead sulfide (PbS) absorber coated on a two-layer mesoporous structure prepared according to the procedure in this Example.

### Example 4

Elvanol 75-15 from Dupont was cross-linked using Kymene (Hercules, Ashland). TiO₂ (P25) powder was dispersed on a 1:1 ratio in a 10% solution of Elvanol 75-15 in water using a Netzsch mill. Kymene was then added in a 1:1 ratio to Elvanol to impart crosslinking. The resulting dispersion was coated onto an ITO-coated PET to create a 1 micron thick deposited film. The coating was then cured at 125° C. for 3 minutes to allow the Kymene to crosslink with Elvanol. The layer appeared as a white translucent coating. The second coating used a standard autoclave process to produce titania nanoparticles (as described in Int. J. Electrochem. Sci., Vol. 7, 2012) that were diluted to 5% solids and coated on top of the first coating. It should be understood a solvothermal process, in lieu of an autoclave process, may also be employed. The second layer was observed to be absorbed into the first layer, making the combination of layers appear window clear.

### Example 5

Numerous PV cells were prepared using a test architecture of PET Film/ITO/TiO₂ Layer 1/TiO₂ Layer 2/P3OT/PEDOT/Ag with different polymers as the binder in TiO₂ Layer 1 Ink. This cell structure creates a sufficient and simple platform for observing the performance of the LT TiO₂, separate from standard characterization measurements. A selection of polymeric binders was made in order to establish sensitivities in the low temperature TiO₂ system. The choice of polymer was primarily based on materials that would be less susceptible to degradation by photoactive TiO₂. Styrene acrylates, aliphatic polycarbonate polyurethanes, polycarbonate aliphatic urethane-acrylics, and aliphatic urethane acrylics were tested. Each polymer was mixed separately into a functional TiO₂ ink at identical formulation ratios and components. PV cells were then fabricated according to the procedure described in Example 2 above. Both initial performance and light degraded measurements were made with a standard IV measurement system at 1000 w/cm². Coating performance and quality observed are shown in Table 3.

TABLE 3

| Binder Type | Coating Quality |
|---|---|
| styrene acrylate | Some visible agglomerates and edge effect. |
| aliphatic polycarbonate | More uniform across coating, slight agglomeration deposits visible |
| polyurethane | as in vial, standard coating settings work well, some large deposits |
| | at top of coating, very slight edge effect, smooth coating |
| aliphatic polycarbonate | very smooth coating, no agglomerates, more uniform than 9603, |
| polyurethane | darker edge effect then others |
| polycarbonate aliphatic | glossy finish, agglomerates present and heavier edge effect, the |
| urethane/acrylic | center of the coating is more iridescent and has inconsistent |
| | deposits of agglomerates, quality of film seems to be unique from |
| | others. |
| aliphatic urethane acrylic | Heavily agglomerated, similar wet out to control, similar edge |
| | effect as control, stiff line along edges |
| aliphatic urethane | wet out a little more than the control, mostly smooth and uniform |
| | with similar edge effect as the control, slight agglomeration in the |
| | field |
| aliphatic urethane | standard settings good, no particles deposits to mention, very |
| | uniform and smooth in terms of dispersion, unique drying pattern |
| | present like water receding from the beach, uniformity of coating |
| | not consistent across |

Upon cell completion, the PV cells were measured under 1 sun in air without temperature control. Results are shown in Table 4, where the control (A1127) is a two-layer cell. Table 5 provides the electrical performance for a one-layer system for comparison. It was determined that there was less initial performance deviation than a similarly sized group of cells made of all the same materials. Thus the initial performance results were not sufficient to determine any benefit from one type of polymer binder to another. It was concluded that the LT TiO₂ system designed was robust enough to withstand significant broad sweep changes of a major component.

TABLE 4

| | 23.18 | ° C. | 0.42 | RH | |
|---|---|---|---|---|---|
| | Voc | Jsc | Eff | FF | Rs |
| Control | 0.64 | 0.26 | 0.08 | 42.28 | 1328.00 |
| (A1127) | | | | | |
| RU21075 | 0.67 | 0.20 | 0.06 | 41.30 | 1930.25 |
| RU13442 | 0.64 | 0.29 | 0.09 | 44.13 | 1066.75 |
| R9036 | 0.63 | 0.22 | 0.06 | 43.23 | 1553.50 |
| R9045 | 0.64 | 0.18 | 0.05 | 40.94 | 2206.25 |
| R972 | 0.63 | 0.22 | 0.06 | 39.96 | 1704.75 |
| R9603 | 0.58 | 0.31 | 0.08 | 38.41 | 1127.50 |
| Average | 0.63 | 0.24 | 0.07 | 41.46 | 1559.57 |
| Standard | 0.02 | 0.047353426 | 0.01 | 1.8022866 | 389.12 |
| Deviation | | | | | |
| Percentage | 0.04 | 0.20 | 0.20 | 0.04 | 0.25 |

TABLE 5

| Voc | Jsc | Eff | FF | Rs |
|---|---|---|---|---|
| 0.092 | 0.047 | 0.00 | 26.4 | 1610 |

Following initial IV measurements, the cells were passivated from air and humidity and placed them into a temperature controlled 1 sun light soaking chamber. They were measured for performance periodically and put back in the chamber for continued light soaking. After 20 hours of light degradation, a less than 1% negative slope was observed in the majority of the group with a reasonable fit (r²). See Table 6. The slope and fit were plotted and determined by measurement of 6 points during the 20 hour interval.

TABLE 6

| PV cell | Binder Type | slope | r² |
|---|---|---|---|
| 1 | A1127 | −0.0135 | 0.86 |
| 2 | RU21075 | −0.0075 | 0.84 |
| 3 | RU13442 | −0.0096 | 0.92 |
| 4 | R9036 | −0.0077 | 0.86 |
| 5 | R9045 | −0.0073 | 0.82 |
| 6 | R972 | −0.0062 | 0.78 |
| 7 | R9603 | −0.0118 | 0.85 |
| | Average | −0.0091 | |
| | St. Deviation | 0.0025 | |
| | Percentage | −0.2730 | |

### Example 6

The coating in Example 1 above was used as the substrate in this Example. 40% conc. of PbI₂ in DMF was coated onto the substrate, followed by dipping the coated substrate into a 10 mg/mL solution of methyl ammonium iodide. The resulting substrate was then coated with spiro-OMeTAD, and then finished with an evaporated gold top electrode. FIG. 6 is a SEM image showing a cross-section of the resulting product.

### Example 7

PING (produced by PURETi), an inorganic binder, was used in this Example to demonstrate its effectiveness in producing a durable matrix for the TiO₂ layers. Because of the molecular compatibility, the binder was observed to form a strong bond to the TiO₂ particles and did not degrade during photocatalytic activity. This material was mixed at a ratio of 1:3 binder to particles and coated on an ITO-coated PET substrate to create a sub-micron thick deposited film. The coated film was light cured in ambient conditions for optimum performance. The layer is then filled with the second coating of precursor materials or nanoparticles to further index match and complete the conductive path throughout the N-Type layer. This double layer can subsequently be coated with different P-type absorbers to get different PV cell configurations and different performance characteristics such as color, transparency and power density.

### Example 8

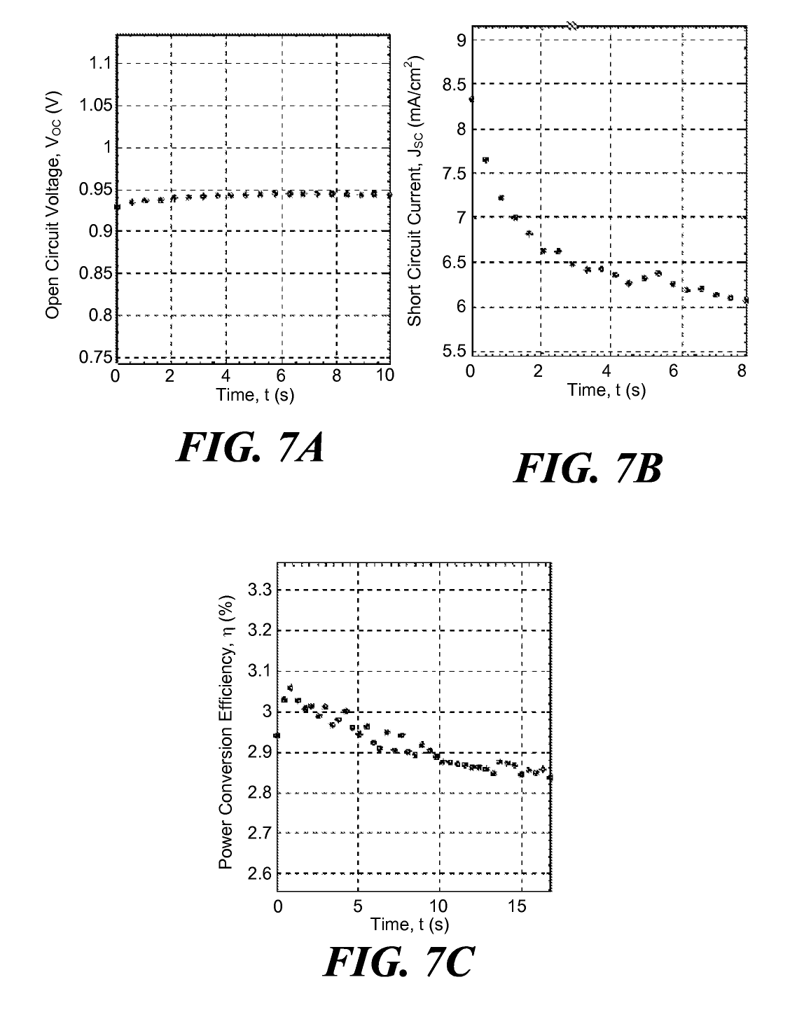

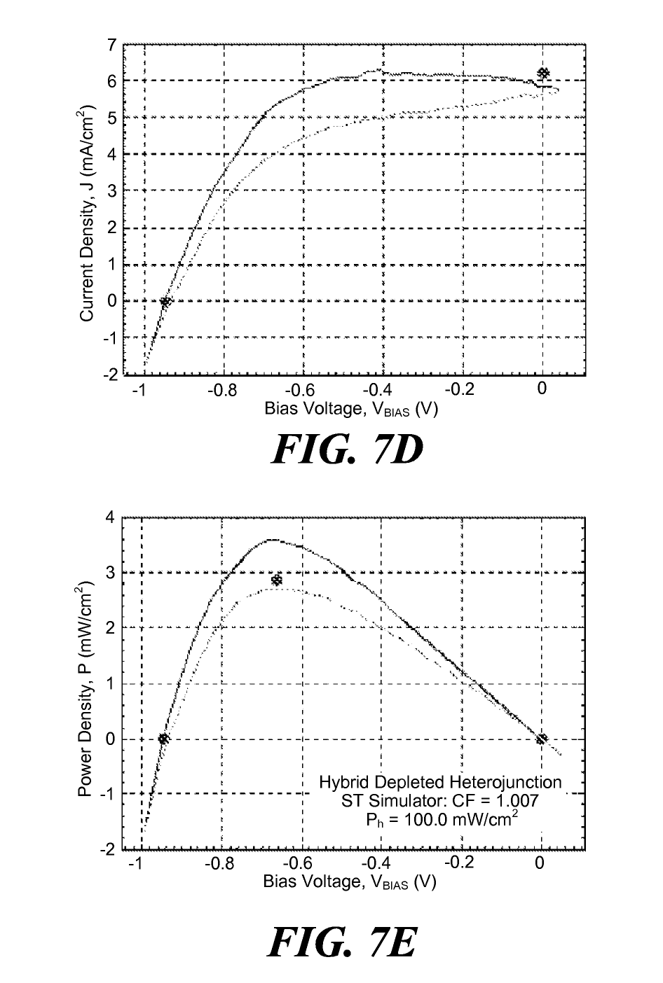

The coating in Example 1 above was used as the substrate in this Example. A lead iodide-based perovskite absorber was then coated on top as follows. First, a PbI₂ layer was spin coated on top of the mesoporous TiO₂ layer, and then the PbI₂ layer was dipped into a CH₃NH₃I IPA solution in order to convert PbI₂ to CH₃NH₃PbI₃ perovskite. Such perovskite was formed in situ, and was deposited within the pores of the mesoporous structure (of the coating in Example 1). The resultant cell performance is summarized in FIGS. 7A-7E.

What is claimed is:

1. A method of coating a conductive surface with a multi-layer mesoporous structure, comprising:
combining a plurality of first photocatalytic particles, binder and a first dispersion medium to form a first photocatalytic dispersion;
coating a conductive surface with the first photocatalytic dispersion to form a first layer over the conductive surface;
curing or partially curing the first layer at a temperature of less than 200° C. to form a porous first layer;
combining a plurality of second photocatalytic particles and a second dispersion medium to form a second photocatalytic dispersion; and
coating the porous first layer with the second photocatalytic dispersion to form a second layer over the porous first layer, wherein the formation of second layer over the porous first layer produces a conductive surface coated with a multi-layer mesoporous structure.

2. The method of claim 1, wherein the ratio of the amount of first photocatalytic particles to the amount of binder present in the first photocatalytic dispersion, expressed as pigment volume concentration, is 0.36 to 0.65.

3. The method of claim 1, wherein the conductive surface is an indium tin oxide surface or a fluorinated tin oxide surface.

4. The method of claim 1, wherein the first photocatalytic particles and the photocatalytic particles are each independently semiconductive oxide particles.

5. The method of claim 4, wherein the first photocatalytic particles and the second photocatalytic particles are each independently titanium dioxide particles, zirconium dioxide particles, zinc oxide particles, or any combination thereof.

6. The method of claim 1, wherein the plurality of first photocatalytic particles has an average particle size between 10 nm and 250 nm; and the plurality of second photocatalytic particles has an average particle size between 5 nm and 50 nm.

7. The method of claim 1, wherein the binder is a resin, a rubber, an elastomer, or any combinations thereof.

8. The method of claim 1, wherein the binder comprises polyacrylate, polythiophene, polyvinylalcohol, or any combinations thereof.

9. The method of claim 1, wherein the binder comprises metal peroxide.

10. The method of claim 1, wherein the first dispersion medium and the second dispersion medium each independently comprises water, an alcohol, a glycol, an ether, a glycerol, an amide, a ketone, a hydrocarbon, an aromatic, a silicone oil, a halogenated hydrocarbon, a halide, an ester, or any combinations thereof.

11. The method of claim 1, wherein the first dispersion medium and the dispersion medium each independently comprises water, methyl alcohol, ethyl alcohol, isopropyl alcohol, butyl alcohol, allyl alcohol, ethylene glycol, propylene glycol, diethylene glycol, polyethylene glycol, polypropylene glycol, diethylene glycolmonoethyl ether, polypropylene glycol monoethyl ether, polyethylene glycol monoallyl ether, polypropylene glycol monoallyl ether, glycerol, glycerol monoethyl ether, glycerol monoallyl ether, N-methylpyrrolidone, tetrahydrofuran, dioxane, methyl ethyl ketone, methyl isobutyl ketone, liquid paraffin, decane, decene, methyl naphthalene, decalin, kerosene, diphenyl methane, toluene, dimethyl benzene, ethyl benzene, diethyl benzene, propyl benzene, cyclohexane, partially hydrogenated triphenyl, polydimethyl, siloxanes, partially octyl-substituted polydimethyl siloxane, partially phenyl-substituted polydimethyl siloxane, fluorosilicone oil, chlorobenzene, dichlorobenzene, bromobenzene, chlorodiphenyl, chlorodiphenyl methane, fluoride, ethyl benzoate, octyl benzoate, dioctyl phthalate, trioctyl trimellitate, dibutyl sebacate, ethyl(meth)acrylate, butyl(meth)acrylate, dodecyl (meth)acrylate, xylene, hexane, or any combinations thereof.

12. The method of claim 1, wherein the first layer is cured or partially cured at a temperature of between 100° C. and 150° C.

13. The method of claim 1, wherein at least a portion of the second photocatalytic dispersion penetrates or partially penetrates at least a portion of the pores in the porous first layer.

14. The method of claim 1, further comprising coating the multi-layer mesoporous structure of conductive surface with a P-type material.

15. The method of claim 14, wherein the P-type material is perovskite.

16. The method of claim 14, wherein less than 1% of the P-type material penetrates the multi-layer mesoporous structure of the conductive surface to create a bilayer P-N heterojunction.

17. A method of coating a conductive surface with a multi-layer mesoporous structure, comprising:
combining a plurality of first N-type semiconductive particles, polymeric binder and a first dispersion medium to form a first semiconductive dispersion;
coating a conductive surface with the first semiconductive dispersion to form a first layer over the conductive surface;
curing or partially curing the first layer at a temperature of less than 200° C. to form a porous first layer;
combining a plurality of second N-type semiconductive particles and a second dispersion medium to form a second semiconductive dispersion; and
coating the porous first layer with the second semiconductive dispersion to form a second layer over the porous first layer, wherein the formation of second layer over the porous first layer produces a conductive surface coated with a multi-layer semiconductive structure.

18. The method of claim 17, wherein the N-type semiconductive particles comprise wide band gap N-type semiconductive particles.

19. A conductive surface coated with a multi-layer mesoporous structure according to the method of claim 1.

20. A photovoltaic cell comprising a substrate with the conductive surface of claim 19.
